(19) United States
(12) Patent Application Publication
(10) Pub. No.: US 2008/0302927 A1
(43) Pub. Date: Dec. 11, 2008

(54) APPARATUS FOR HOLDING HOUSEHOLD OBJECTS

(76) Inventor: JAMES TREDINNICK, Fontana, CA (US)

Correspondence Address: LAW OFFICE OF MAI VU PARE, 9107 WILSHIRE BLVD. #450, BEVERLY HILLS, CA, 90210, US

(21) Appl. No.: 11/760,751

(22) Filed: Jun. 9, 2007

(51) Int. Cl. F16M 11/00

(52) U.S. Cl. 248/176.1

(57) ABSTRACT

The present invention relates to a novel household object holder comprising a platform constructed from pliable material. The platform comprises a lattice framework and one or more footings extending perpendicular or substantially perpendicular from said platform and supporting said platform away from a surface on which the footings are resting. The present invention provides a novel means of holding and drying household objects and maximizes the useful life of such objects by reducing odor, mildew, and decomposition.

### BACKGROUND OF THE INVENTION

The present invention relates to an improved apparatus for holding and drying household cleaning objects such as soap, sponges, and cleaning pads.

Prior art devices fail to provide a simple and effective means of maintaining a clean and dry environment in which to hold household objects such as those identified above. Constant moisture surrounding such objects leads to mold and mildew accumulation on said objects, producing an offensive odor unless adequate means are provided for ventilation. Excess moisture surrounding a bar of soap is also absorbed by soap and hastens its deterioration unless adequate means of air circulation are provided.

Many prior art devices have attempted to address the problem of moisture accumulation by providing porous or grid-like contraptions on which household objects are placed. Such devices however, generally require the use of a collecting receptacle in which to collect excess moisture or allow for moisture to spill and drain onto a surface on which such devices rest, requiring constant clean-up.

An additional shortcoming of the prior art relate to safety. Many prior art devices are constructed from rigid materials such as ceramic, hard plastic, metal, or glass. Some prior art devices may incorporate rigid metal or hard plastic spikes intended to be lodged within a bar of soap. Such prior art devices may pose a hazard in the event they are dropped and/or shattered on slippery areas such as bathroom or kitchen floors, and individuals may inadvertently step on them.

Therefore it is an object of the present invention to overcome the shortcomings mentioned above and provide an apparatus for holding and drying household objects;

Specifically, it is an object of the present invention to provide a simple apparatus for minimizing accumulation of moisture surrounding household objects being held within it.

It is an additional object of the present invention to provide an apparatus for holding household objects, where said apparatus poses no safety risk.

It is also an object of the present invention to provide an apparatus for holding household objects that may be inexpensive to manufacture.

### SUMMARY OF THE INVENTION

The invention comprises a raised platform supported by footings that may be constructed from pliable materials such as polyurethane or soft plastic. The platform includes a lattice framework, comprising multiple openings throughout the platform. The lattice framework comprises multiple openings with beveled edges from which drops of moisture may rest suspended until evaporated. Use of the apparatus is accomplished simply by positioning the apparatus in an orientation so that the platform is raised above the surface on which the apparatus is resting. A household item such as a sponge or bar of soap is placed on top of the platform. The pliable nature of the material from which the apparatus is constructed allows for the platform to assume a concave orientation when receiving weight such as a bar of soap. The concave orientation allows for the household item to be securely held within the apparatus, having a hammock-like effect when bearing the weight of items such as a bar of soap.

### BRIEF DESCRIPTION OF DRAWINGS

FIG. 1 depicts a conventional soap holder with a bar of soap.

FIG. 2 depicts a perspective view of the present invention with lines 4-4 and 2A indicating cross sections of the apparatus.

FIG. 2A illustrates a cross section of the apparatus indicated by line 2A in FIG. 2.

FIG. 3 depicts a perspective view of the present invention contained within a conventional soap holder.

FIG. 4 depicts a cross sectional view of the present invention from the section indicated by dashed lines labeled “4-4” on FIG. 2.

FIG. 5 depicts a perspective view of the present invention when placed in an upturned position.

FIG. 6 depicts the ability for air to circulate around a bar of soap when placed on the present invention.

FIG. 7 depicts the pliable nature of the present invention.

FIG. 8 depicts the ability of the present invention to assume a concave configuration when holding a bar of soap.

### DETAILED DESCRIPTION OF THE PRESENT INVENTION

While the present invention may be used to hold a variety of household cleaning items, such as sponges, steel wool, cleaning pads, and soap it will be discussed specifically in the context of use with a bar of soap.

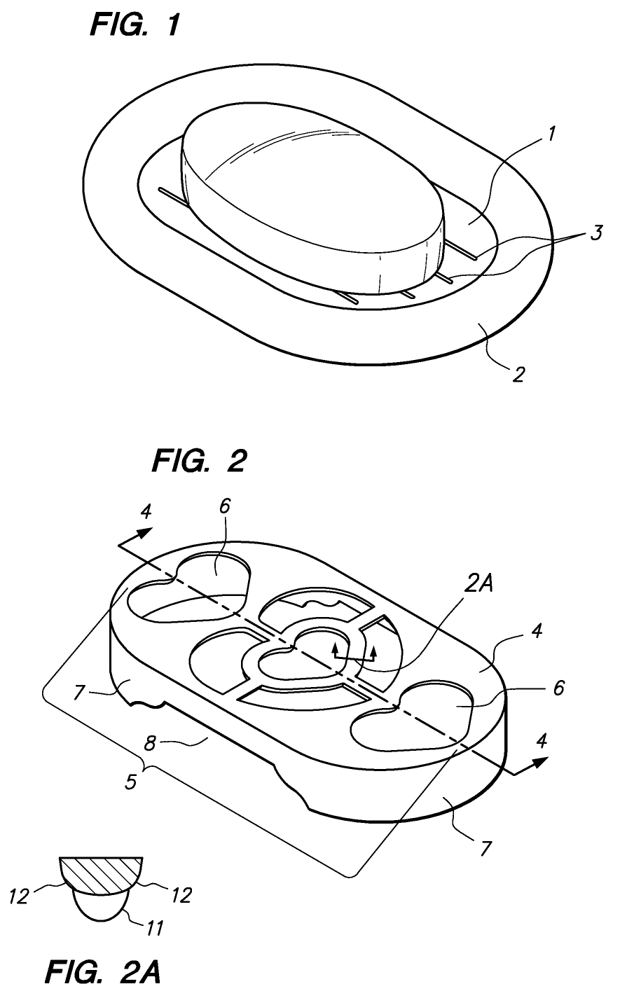

FIG. 1 shows a widely used prior art soap holder. Prior art soap holders typically comprise a non-porous receptacle 1 having a slightly walled formation 2 surrounding the receptacle, creating a shallow bowl. Raised projections 3 may be provided within the receptacle, and said projections may extend along the length of the receptacle.

A significant shortcoming of the most widely used prior art is that it fails to create an environment in which excess moisture can be removed from a bar of soap. It also fails to prevent accumulation of moisture surrounding a bar of soap that is being stored. While the projections may allow for some separation of moisture from a bar of soap, it does not prevent the rapid accumulation of moisture within the receptacle, as there are no means of passive removal of moisture within the receptacle. The walled formation, combined with the non-porous receptacle creates a perpetually wet environment, resulting in the rapid decomposition of soap.

FIG. 2 depicts a perspective view of the present invention. In its preferred embodiment, it is constructed from a soft, pliable material such as polyurethane or flexible polyvinyl chloride. The apparatus comprises a platform 4. Said platform includes a lattice framework 5 having multiple openings distributed across the platform. The openings may include ornate shapes, such as hearts 6 or other fanciful patterns. When oriented in a position for use, the platform is raised above the surface on which the apparatus is resting via footings 7 that may extend around the perimeter of the platform. The footings are positioned perpendicular or substantially perpendicular to the platform and should project a sufficient height so that the platform does not touch a surface on which the footings are resting. In the preferred embodiment of the invention, the footings project 1.5 cm from the platform.

The footings 7 may include decorative cut-outs 8 that provide for gaps between the platform and the surface on which the apparatus is resting. The cut-outs allow for increased circulation surrounding the object placed on the platform. In the preferred embodiment of the invention, the footings are constructed from the same, pliable material as the platform.

FIG. 2A shows a detailed view of the cross section depicted by line 2A in FIG. 2. The lattice framework openings comprise beveled edges 12 and is seen in the cross section of FIG. 2A. Curvature created by the beveled edges enhances moisture removal by using surface tension, cohesion, and adhesion to collect and suspend moisture for evaporation. The opportunities created for air circulation surrounding the apparatus enhance the evaporation of drops of liquid 11 suspended from the beveled edges 12 reducing the amount of water and soap film landing onto the surface on which the apparatus rests.

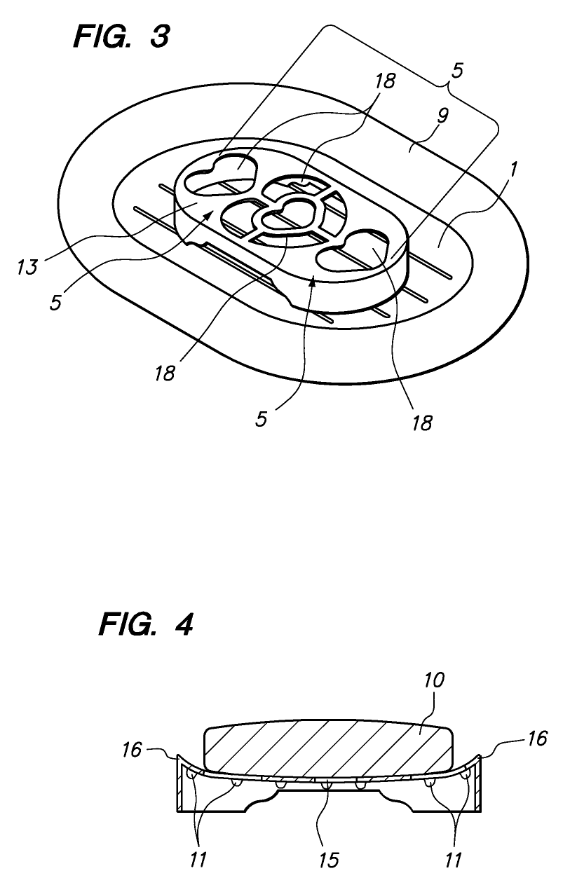

FIG. 3 depicts a manner in which the present invention may be used in conjunction with a prior art soap holder 9. The present invention may be placed within a receptacle of a prior art soap holder 1. When a bar of soap (not shown) is placed on top of the platform of the invention, excess moisture surrounding the bar of soap may travel in a downward direction. While the present invention is intended to minimize the amount of moisture that falls from the top surface of the platform 13 due to the novel design of the beveled edges of the lattice framework 5, excess moisture may fall onto the surface of the prior art soap holder when it is used in the manner as demonstrated in FIG. 3.

The lattice framework of the present invention provides multiple, large openings 18 for removal of moisture from the top surface of the platform. This configuration allows for numerous locations where drops of moisture can hang suspended from the edges of the lattice framework openings. If excessive moisture surrounds the household object being held, a prior art soap holder may be used to capture drops of moisture that may fall from the lattice framework. However, for normal, customary use of soap and other household objects, moisture remains suspended from the lattice framework due to the novel design, preventing spillage onto the surface on which the apparatus rests.

FIG. 4 depicts a cross sectional view of the apparatus with a bar of soap 10. The location of the cross section is identified by line “4-4” in FIG. 2. The pliable nature of the material from which the apparatus is constructed allows the platform to assume a concave configuration when bearing weight. This concave configuration enhances the ability of the apparatus to hold a bar of soap securely in position, as the weight of the bar of soap is directed towards the center of the platform 15, and the perimeter of the platform 16 remains above, similar to a small-scale sling or hammock.

The concave configuration further improves drying of the bar of soap because excess moisture from normal use will have a tendency to travel downward, along the slope of the concave platform. Drops of liquid 11 are suspended from the platform and remain suspended until evaporated.

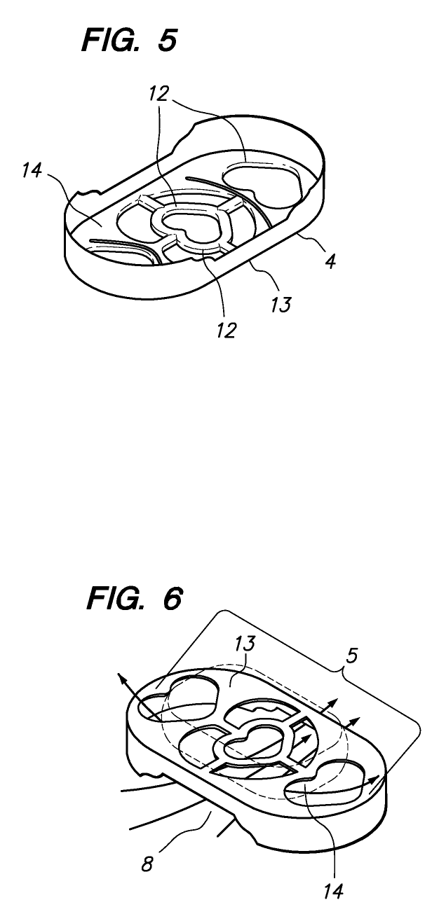

FIG. 5 shows the present invention in an inverted position. In the inverted position, the platform 4 rests flush against the surface on which the apparatus is resting. In the preferred embodiment of the invention, individual openings comprising the lattice framework further comprise beveled edges 12. The beveled edges may enhance removal of moisture from a bar of soap when the apparatus is placed in an upright position by facilitating the travel of moisture away from the top surface of the platform 13 for suspension onto the underside of the platform 14.

FIG. 6 depicts the opportunity for ventilation created by the lattice framework 5 and footing cut-outs 8 of the apparatus. Air can circulate the top surface of the platform 13 as well as the underside 14. When the bar of soap is placed on top of the platform, excess moisture surrounding the bar of soap may be evaporated while suspended from the lattice framework.

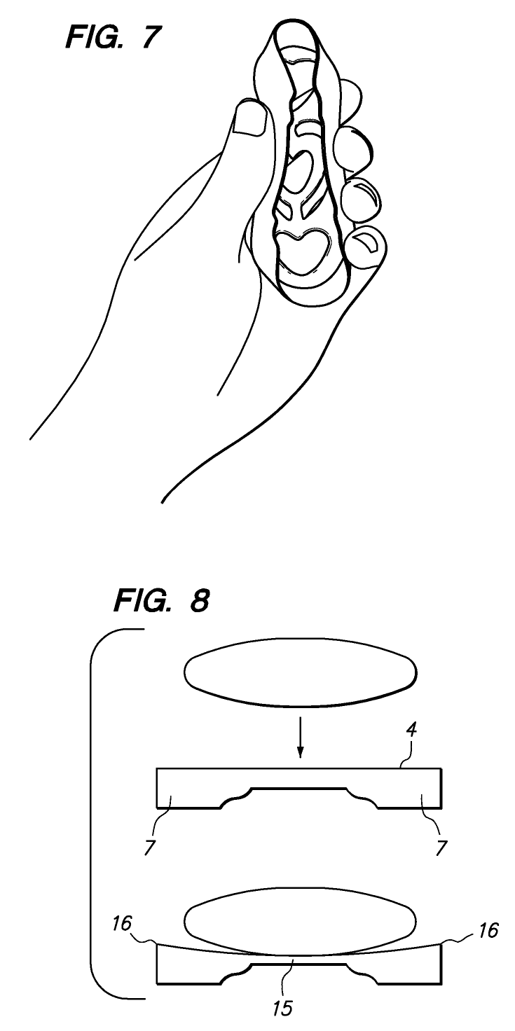

FIG. 7 illustrates the pliable nature of the apparatus. The material may be twisted and bent into different configurations when tension or pressure is applied. When tension or pressure is removed, the apparatus returns to its original configuration. Examples of suitable materials that may be used to construct the present invention include, but are not limited to polyvinyl chloride, elastollan, elastomer, and polyurethane. Anti-bacterial agents, anti-fungal agents, and/or UV shielding agents known in the art may also be incorporated to the above materials for additional benefits to the user.

While many different materials may be used to construct the apparatus, suitable materials must be pliable and form a concave configuration when bearing weight typical of a bar of soap. Representative weights for typical bars of soap intended to be used with the apparatus may range from 3-6 ounces. The apparatus is useful however, for holding bars of soap having lesser weight and in fact is especially efficient in drying soap as it decomposes to smaller and smaller sizes through continued use.

The pliable nature of the material is essential for moisture removal by allowing the apparatus to form a concave configuration when bearing the weight of a bar of soap. Moisture will have a tendency to travel down this slope. The concave configuration of the apparatus provides additional utility by securing the bar of soap within the apparatus because the perimeter of the platform partially engulfs the bar of soap. Similar to the function of a hammock supporting a body by suspension, the pliable nature of the platform allows it to securely hold a bar of soap by suspension, with the perimeter area of the platform resting at a higher position than the center of the platform, as detailed in FIG. 8.

FIG. 8 illustrates use of the apparatus. When the apparatus is not in use, the platform 4 rests perpendicular or substantially perpendicular to the footings 7. The pliable nature of the material forming the apparatus allows for a concave configuration of the apparatus to form when bearing weight from a bar of soap as depicted in FIG. 8. The center area of the platform 15 rests at a lower point than the perimeter of the platform 16, serving dual purposes of enhancing moisture removal, and securing the bar of soap within the apparatus.

With respect to the above description, it is to be realized that the optimum dimensional relationships for the parts of the invention, to include variations in size, materials, shape, form, function, manner and use are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

What is claimed is:

1. A household object holder comprising:
A platform constructed from pliable material;
Said platform comprises a lattice framework; and
One or more footings extending perpendicular or substantially perpendicular from said platform and supporting said platform away from a surface on which the footings are resting.

2. The household object holder of claim 1 wherein said footings comprise cut-outs.

3. The household object holder of claim 1 wherein said footings are constructed from pliable material.

4. The household object holder of claim 1 wherein said platform and footings are constructed from soft plastic.

5. The household object holder of claim 1 wherein said platform and footings is constructed from polyurethane.

6. The household object holder of claim 1 wherein openings within said lattice framework possess beveled edges.

7. The household object holder of claim 1 wherein antibacterial and/or anti-fungal agents are incorporated within the platform and footings.

8. The household object holder of claim 1 wherein UV blocking agents are incorporated within the platform and footings.

9. A soap holder comprising:
A platform constructed from soft, pliable material;
Said platform comprises a lattice framework;
Said lattice framework comprise beveled edges from which drops of moisture remain suspended until evaporated; and
One or more footings extending perpendicular or substantially perpendicular from said platform and supporting said platform away from a surface on which the footings are resting.

10. The soap holder of claim 9 wherein said footings comprise one or more cut-outs.

11. The soap holder of claim 9 wherein said platform forms a concave configuration when bearing weight from a bar of soap.

12. The soap holder of claim 9 wherein said footings are constructed from pliable material.

13. The soap holder of claim 9 wherein said footings and platform are constructed from polyurethane.

14. The soap holder of claim 9 wherein said footings and said platform is constructed from soft plastic.

15. The soap holder of claim 9 wherein the platform and footings incorporate antibacterial and/or anti-fungal agents.

16. The soap holder of claim 9 wherein the platform and footings incorporate UV blocking agents.
